(19) United States
(12) Patent Application Publication
(10) Pub. No.: US 2012/0033345 A1
(43) Pub. Date: Feb. 9, 2012

(54) Electrochemical capacitor and method of manufacturing the same

(75) Inventors: Hong Seok Min, Yongin-si (KR); Bae Kyun Kim, Seongnam-si (KR); Hyun Chul Jung, Yongin-si (KR)

(73) Assignee: SAMSUNG ELECTRO-MECHANICS CO., LTD., Suwon (KR)

(21) Appl. No.: 12/926,567

(22) Filed: Nov. 24, 2010

(30) Foreign Application Priority Data
Aug. 6, 2010 (KR) 10-2010-0075999

(51) Int. Cl. H01G 9/008; H01G 7/00

(52) U.S. Cl. 361/500; 156/192

(57) ABSTRACT

Disclosed is an electrochemical capacitor and method for manufacturing the same. The electrochemical capacitor includes: at least two winding-type separators which are wound in a spiral shape and are stacked; and stacking-type first and second electrodes which are alternately interposed between the wound separators, respectively.

### CROSS-REFERENCE(S) TO RELATED APPLICATIONS

This application claims the benefit under 35 U.S.C. Section [120, 119, 119(e)] of Korean Patent Application Serial No. 10-2010-0075999, entitled “Electrochemical Capacitor And Method Of Manufacturing The Same” filed on Aug. 6, 2010, which is hereby incorporated by reference in its entirety into this application.

### BACKGROUND OF THE INVENTION

1. Field of the Invention

The present invention relates to an electrochemical capacitor; and, more particularly, to a hybrid-type electrochemical capacitor which is provided with winding-type separators and stacking-type electrodes, and a method for manufacturing the same.

2. Description of the Related Art

In general, an electrochemical energy storage apparatus has been used as a core component of finished products in various appliances like portable information communication appliances, and electronic appliances. It is expected to be used as an innovative energy source in a new and renewable energy field applicable to the future electric vehicles and portable electronic devices.

Of the electrochemical energy storage apparatuses, an electrochemical capacitor may be divided into an electrical double layer capacitor employing an electrochemical double layer principle, and a hybrid super-capacitor employing electrochemical oxidation-reduction process.

Herein, the electrochemical double layer capacitor has been widely used in fields requiring high-output energy characteristics, but it has a problem of a low capacitance. In comparison, the hybrid super-capacitor has been actively researched as an alternative solution to improve capacitance characteristics of an electrical double layer capacitor. In particular, a Lithium Ion Capacitor LIC of hybrid super-capacitors may have a storage capacitance three and four times as large as the electrical double layer capacitor.

The electrochemical capacitor may be provided with cathodes and anodes alternately stacked, and separators which are interposed therebetween to electrically separate the stacked cathodes and anodes.

Meanwhile, the electrochemical capacitor may be classified into a winding-type electrochemical capacitor and a stacking-type electrochemical capacitor according to the way the cathodes, the separators, and the anodes are assembled together with one another. Herein, the winding-type electrochemical capacitor has a structure in which cathodes, separators, and anodes in a sheet shape for each of them are stacked in order and wound in a circle shape. The stacking-type electrochemical capacitor has a structure where cathodes and anodes with pattern shapes are alternately stacked with respect to the pattern-shaped separators interposed therebetween.

The winding-type electrochemical capacitor has a superior productivity to the stacking-type electrochemical capacitor, but it may have a problem in that crack occurs in a bending portion when winding is made, which results in short-defect between the cathodes and the anodes. In order to solve this problem, the winding-type electrodes are required to have binder's content at a high ratio, and thus the electrochemical capacitor has lowered electrical characteristics. Also, in case of the winding type, it is necessary to perform a rigid packaging process in order to keep the winding shape unchanged.

However, the winding type has no problems with short-defect or packaging caused by crack in comparison with the stacking type, but has disadvantages in that productivity is lowered due to individual handling of pattern-shaped cathodes, anodes, and separators.

Therefore, there has been a demand to develop a technology for a new electrochemical capacitor which can supplement both lacks of the winding-type and stacking-type electrochemical capacitors in the prior art.

### SUMMARY OF THE INVENTION

The present invention has been proposed in order to overcome the above-described problems and it is, therefore, an object of the present invention to provide a hybrid-type electrochemical capacitor which is provided with winding-type separators and stacking-type electrodes, thereby satisfying a productivity's improvement effect provided as an advantage of a wining type, as well as the yield's improvement effect provided as an advantage of a stacking type, and a method for manufacturing the same.

In accordance with one aspect of the present invention to achieve the object, there is provided an electrochemical capacitor including: at least two winding-type separators which are wound in a spiral shape and are stacked; and stacking-type first and second electrodes which are alternately interposed between the wound separators, respectively.

Herein, the electrical capacitor further includes adhesion members for bonding and fixing the first and second electrodes on the separators.

Also, each of the adhesion members includes any one selected from the group consisting of PTFE, PVP, PVdF, EPDM, PDMS, SBR, and CMC.

Also, the first and second electrodes include first and second terminals for connection to an external power source, respectively, the first and second terminals being partially bonded on the separators in such a manner that the first and second electrodes are fixed on the separators.

In accordance with another aspect of the present invention to achieve the object, there is provided an electrochemical capacitor including: a sheet-shaped first separator; a plurality of first electrodes which are bonded in a row on the first separator and have pattern shapes; a first adhesion member for bonding the first electrodes on the first separator; a sheet-shaped second separator which is disposed above the first separator with the first electrodes; a plurality of second electrodes which correspond to the first electrodes, respectively, the second electrodes being bonded in a row on the second separator and having pattern shapes; and a second adhesion member for bonding the second electrodes on the second separator, wherein the first and second separators are wound in a spiral shape in such a manner that the first and second electrodes are alternately interposed between the wound first and second separators, respectively.

Also, each of the first and second adhesion members includes adhesive resin.

Also, each of the first and second adhesion members includes any one selected from the group consisting of PTFE, PVP, PVdF, EPDM, PDMS, SBR, and CMC.

Also, the first electrode includes a first terminal extensively formed from one side thereof, and the second electrode includes a second terminal extensively formed from the other side thereof, and the first and second adhesion members are interposed between the first separator and a part of the first terminal and between the second separator and a part of the second terminal, respectively.

Also, the second separator is provided with an unoccupied space at a point where winding starts to be made, in such a manner that the unoccupied space corresponds to the first electrode disposed at a point where winding starts to be made.

Also, the number of the second electrodes are less by one than the number of the first electrodes.

Also, the second separator surrounds the second electrode which is disposed in the middle of the stacked second electrodes.

In accordance with another aspect of the present invention to achieve the object, there is provided a method for manufacturing an electrochemical capacitor including the steps of: bonding first electrodes with pattern shapes in a row on a sheet-shaped first separator by using a first adhesion member; bonding second electrodes with pattern shapes in a row on a sheet-shaped second separator which corresponds to the first separator, by using a second adhesion member; aligning the second separator with the second electrodes on the first separator with the first electrodes; and winding the aligned first and second separators in such a manner that the first and second electrodes are alternately stacked.

Also, each of the first and second adhesion members includes adhesive resin.

Also, each of the first and second adhesion members includes any one selected from the group consisting of PTFE, PVP, PVdF, EPDM, PDMS, SBR, and CMC.

Also, in the step of bonding the second electrodes with pattern shapes in a row on the sheet-shaped second separator corresponding to the first separator by using the second adhesion member, an unoccupied space corresponding to the first electrode disposed on a point where the first separator starts to be wound is provided on a point where the second separator starts to be wound.

Also, the first and second adhesion members are coated on partial regions of the first and second terminals, respectively.

Also, the first and second adhesion members are coated on the first and second separators, respectively.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view showing an electrochemical capacitor in accordance with a first embodiment of the present invention;

FIG. 2 is an assembled perspective view showing the electrochemical capacitor of FIG. 1;

FIG. 3 is a cross-sectional view showing the electrochemical capacitor taken along a line I-I′ of FIG. 2;

FIG. 4 is a cross-sectional view showing the electrochemical capacitor taken along a line II-II′ of FIG. 2; and

FIGS. 5 to 8 are cross-sectional views for explaining a process of manufacturing an electrochemical capacitor in accordance with a second embodiment of the present invention, respectively.

### DETAILED DESCRIPTION OF THE PREFERABLE EMBODIMENTS

Embodiments of an electrochemical capacitor in accordance with the present invention will be described in detail with reference to the accompanying drawings. When describing them with reference to the drawings, the same or corresponding component is represented by the same reference numeral and repeated description thereof will be omitted.

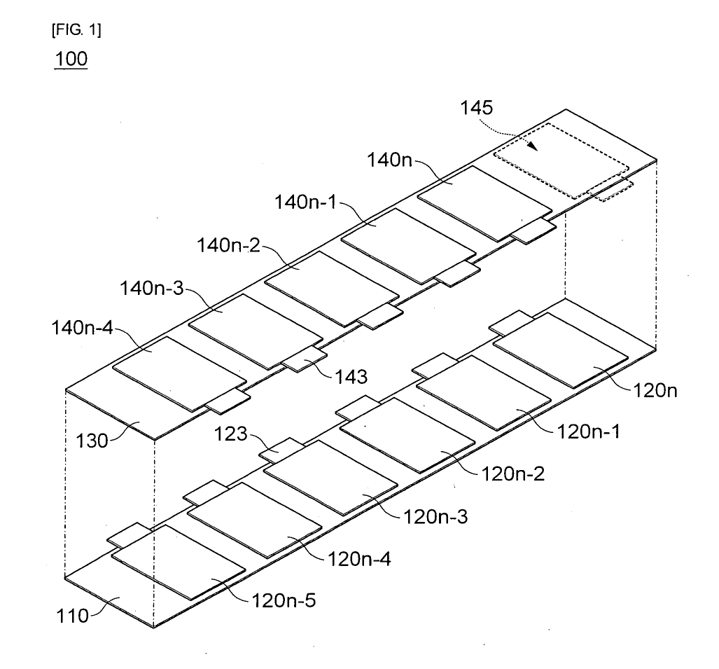

FIG. 1 is an exploded perspective view showing an electrochemical capacitor in accordance with a first embodiment of the present invention.

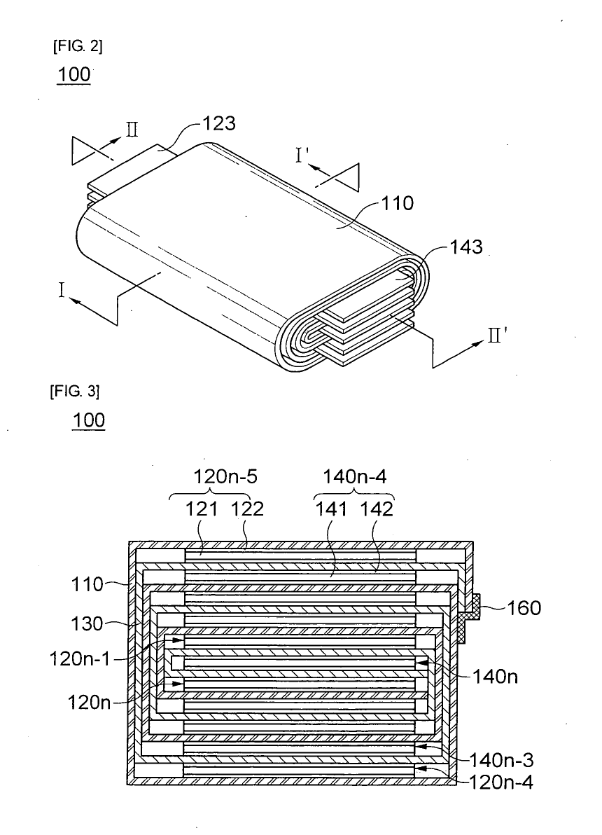

FIG. 2 is an assembled perspective view showing the electrochemical capacitor of FIG. 1.

FIG. 3 is a cross-sectional view showing the electrochemical capacitor taken along a line I-I′ of FIG. 2.

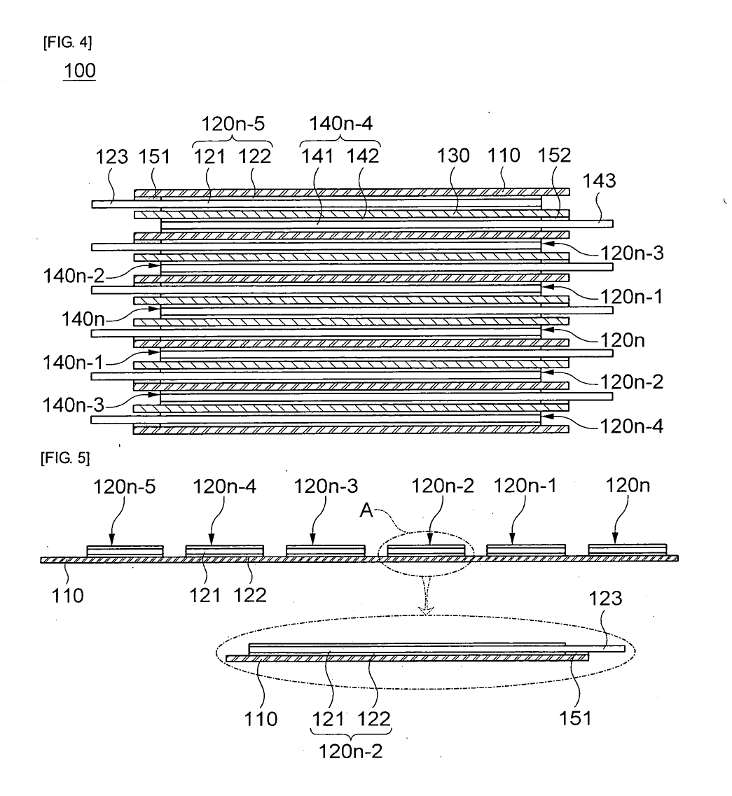

FIG. 4 is a cross-sectional view showing the electrochemical capacitor taken along a line II-II′ of FIG. 2.

Referring to FIGS. 1 to 4, the electrochemical capacitor according to the first embodiment of the present invention may include first and second separators 110 and 130, and first and second electrodes 120n to 120n−5 and 140n to 140n−4. The first and second separators 110 and 130 are wound in a spiral shape (hereinafter, referred to as ‘winding-type’), and the first and second electrodes 120n to 120n−5 and 140n to 140n−4 in sheet shapes are alternately stacked (hereinafter, referred to as ‘stacking-type’) and electrically separated by the first and second separators. Thus, the electrochemical capacitor 100 may have a hybrid type for providing advantages of the winding type and the stacking type.

A detailed description will be given of respective constructions in the electrochemical capacitor 100. The electrochemical capacitor 100 may include first and second separators 110 and 130, first and second electrodes 120n to 120n−5 and 140n to 140n−4, and first and second adhesion members 151 and 152. The first and second separators are in sheet types for each of them (hereinafter, referred to as ‘sheet-shaped’), and the first and second electrodes 120n to 120n−5 and 140n to 140n−4 are in pattern shapes (hereinafter, referred to as ‘pattern-shaped’).

Herein, the first and second separators 110 and 130 may be formed in sheet types, and may be wound in roll shapes. At this time, the first and second separators 110 and 130 play a role of electrically separating the first and second electrodes 120n to 120n−5 and 140n to 140n−4 by being interposed between the first and second electrodes 120n to 120n−5 and 140n to 140n−4.

The first and second separators 110 and 130 may be formed of insulating materials with durability against electrolyte solution and active material. Also, the first and second separators 110 and 130 may be porous for transferring of ions. As for the material of each of the first and second separators 110 and 130, cellulose, polyethylene, polypropylene, and so on may be exemplified. However, the present invention is not limited by the materials of the first and second separators 110 and 130.

The first and second electrodes 120n to 120n−5 and 140n to 140n−4 may have pattern shapes and may be alternatively stacked. At this time, the first and second electrodes 120n to 120n−5 and 140n to 140n−4 may be electrically separated from one another by any one of the first and second separators 110 and 130.

Herein, the first electrodes 120n to 120n−5 may be cathodes. At this time, the first electrodes 120n to 120n−5 each may include an cathode current collector 121 and an cathode active material layer 122 coated on both surfaces of the cathode current collector 121. The cathode current collector 121 may be formed of any one metal selected from the group consisting of Al, Ta, Ti, and Ni. Also, the cathode current collector 121 may be in a thin-film shape and be provided with a plurality of through holes through which ions are effectively transferred. The cathode active material layer 122 may include a carbon material capable of reversibly doping or un-doping ions. For example, the carbon material may include activated carbon.

One side of each of the first electrodes 120n to 120n−5 may be provided with a first terminal 123 used to be electrically connected to an external power source. Herein, the first terminal 123 may be extensively formed from one side of the cathode current collector 121. That is, the cathode current collector 121 and the first terminal 123 may be formed in a body.

The second electrodes 140n to 140n−4 may be anodes. At this time, the second electrodes 140n to 140n−4 each may include a anode current collector 141 and a anode active material layer 142 coated on both surfaces of the anode current collector 141. The anode current collector 141 may be formed of any one metal selected from the group consisting of Cu, Ni, and stainless. The anode current collector 141 may be in a thin-film shape, and may be provided with a plurality of through holes through which ions are effectively transferred. The anode active material layer 142 may be formed of a carbon material capable of reversibly doping or un-doping ions. For example, the anode active material layer 142 may include any one of activated carbon and graphite.

In addition, in case where the electrochemical capacitor 100 is a lithium ion capacitor, lithium ions may have been doped into the anode active material layer 142 in advance.

One side of each of the second electrodes 140n to 140n−4 may be provided with a second terminal 143 used to be electrically connected to an external power source. Herein, the second terminal 143 may be extensively formed from one side of the anode current collector 141. That is, the second terminal 143 and the anode current collector 141 may be formed in a body.

Although it has been illustrated in the embodiment of the present invention that the first electrodes 120n to 120n−5 are cathodes and the second electrodes 140n to 140n−4 are anodes, the present invention is not limited thereto. In case where the first electrodes 120n to 120n−5 are cathodes, the second electrodes 140n to 140n−4 may be anodes.

The first adhesion member 151 may play a role of bonding and fixing the first electrodes 120n to 120n−5 on the first separator 110. Herein, the first adhesion members 151 may be made from a material (i.e., a composition including an adhesive resin with stability against the electrolyte solution and the first terminal 123) having no reactivity with electrolyte solution or the first terminal 123. The adhesive resin may be any one selected from the group consisting of PTFE, PVP, PVdF, EPDM, PDMS, SBR, and CMC, or may be a mixture of two or more thereof. In addition to this, the composition may further include a solvent. As for the solvent, NMP, acetone, and distilled water may be exemplified. Herein, the adhesive resin may be dissolved in the solvent, and thus the composition may be formed in a liquid type. At this time, the first adhesion member 151 may be formed by coating the liquid composition either on the first separator 110 or the first electrodes 120n to 120n−5.

The second adhesion member 152 may play a role of bonding and fixing the second electrodes 140n to 140n−4 on the second separator 130. Herein, the second adhesion member 152 may be formed by selecting the compositions of the first adhesion member 151. At this time, the first and second adhesion members 151 and 152 may be formed of the same composition as each other. The present invention is not limited thereto, and the first and second adhesion members 151 and 152 may also be formed of different compositions from each other.

A detailed description will be given of the electrochemical capacitor 100. Both of the sheet-shaped first and second separators 110 and 130 may be spirally wound around one of the second electrodes 140n to 140n−4, that is, around the second electrode 140n which is disposed in the middle of the stacked second electrodes 140n to 140n−4. At this time, the pattern-shaped first electrodes 120n to 120n−5 and second electrodes 140n to 140n−4 may be alternately stacked with respect to the first and second separators 110 and 130 interposed therebetween, respectively. That is, the electrochemical capacitor 100 may include the wound first and second separators 110 and 130, and the alternately stacked first and second electrodes 120n to 120n−5 and 140n to 140n−4 interposed between the wound first and second separators 110 and 130.

Herein, since the first and second electrodes 120n to 120n−5 and 140n to 140n−4 may be bonded on the first and second separators 110 and 130, respectively, it is possible to perform easy handling of the first and second electrodes 120n to 120n−5 and 140n to 140n−4 during a manufacturing process.

Also, as the first and second electrodes 120n to 120n−5 and 140n to 140n−4 are in pattern shapes, no bending portions are formed on the first and second electrodes 120n to 120n−5 and 140n to 140n−4 at the time of winding, as in the case of a wound type. Therefore, it is possible to prevent crack caused by bending portions of the first and second electrodes 120n to 120n−5 and 140n to 140n−4. Thus, it is possible to prevent a short-defect between the first and second electrodes 120n to 120n−5 and 140n to 140n−4, thereby improving the yield of the electrochemical capacitor 100. Also, the first and second electrodes 120n to 120n−5 and 140n to 140n−4 have a structure which can prevent short-defect by their bending, so that it is possible to reduce a binder content in each of the first and second electrodes 120n to 120n−5 and 140n to 140n−4, in comparison with a winding type. Thus, it is possible to reduce resistance of each in the first and second electrodes 120n to 120n−5 and 140n to 140n−4, and thus to improve electrical characteristics of the electrochemical capacitor 100.

Both sides of the electrochemical capacitor 100 may be provided with the first and second terminals 123 and 143 disposed thereon, respectively. Herein, each of the first and second terminals 123 and 143 may be connected to an external power source.

In the case of the electrochemical capacitor 100, a plurality of first electrodes 120n to 120n−5 may be bonded on the sheet-shaped first separator 110. Herein, a plurality of first electrodes 120n to 120n−5 may be disposed in a row to be separated from one another at a predetermined interval. A partial region of the first terminal 123 disposed on one side of the first electrodes 120n to 120n−5 is disposed on the first separator 110. At this time, by interposing the first adhesion member 151 between the first terminal 123 and the first separator 110, the first electrodes 120n to 120n−5 may be bonded and fixed on the first separator 110. That is, the first adhesion member 151 may be disposed only on the partial region of the first terminal 123 overlapped with the first separator 110. Thus, it is possible to prevent the first electrodes 120n to 120n−5 or the first terminal 123 connected to the external power source from being contaminated due to the first adhesion member 151, thereby minimizing a decrease in electrical characteristics of the electrochemical capacitor 100. Also, the first separator 110 is bonded to the first electrodes 120n to 120n−5 in such a manner that its upper and lower portions are exposed, that is, the first separator 110 has a larger size than those of the first electrodes 120n to 120n−5. Therefore, it is possible to stably prevent the first electrodes 120n to 120n−5 from being short-circuited with second electrodes 140n to 140n−4 at the time of winding the first separator 110.

The second separator 130 bonded to a plurality of the second electrodes 140n to 140n−4 may be placed above the first separator 110 including the first electrodes 120n to 120n−5. A plurality of the second electrodes 140n to 140n−4 may be disposed in a row to be separated from one another at a predetermined interval on the second separator 130. Herein, the first and second electrodes 120n to 120n−5 and 140n to 140n−4 may be disposed to correspond to each other. At this time, an unoccupied space 145 corresponding to the first electrode 120n may be provided on an upper portion of one-side end of the second separator 130, that is, a point where winding begins to be made. The first and second separators 110 and 130 may start to be wound while the second separator 130 covers the upper surface of the second electrode 140n disposed on one side of the unoccupied space 145. That is, after the first and separators 110 and 130 finish to be wound, the second electrode 140n may be disposed in the middle of the stacked electrodes.

Thus, the middle-disposed second electrode 140n is wound by the second separator 130, and thus electrically separated from the first electrodes 120n to 120n−1 disposed above and below the second electrode 140n. Also, as the electrochemical capacitor 100 has the unoccupied space 145 on the point where the second separator 130 starts to be wound, the number of the second electrodes 140n to 140n−4 may be less by one than that of the first electrodes 120n to 120n−5. In addition, the first electrodes 120n−4 and 120n−5 may be disposed on the uppermost and lowermost layers of the electrochemical capacitor 100, respectively.

As in a case of the first electrodes 120n to 120n−5, a partial region of the second terminal 143 disposed on one side of the second electrodes 140n to 140n−4 may be disposed on the second separator 130. At this time, by interposing a second adhesion member 152 between the second terminal 143 and the second separator 130, the second electrodes 140n to 140n−4 may be bonded and fixed on the second separator 130. Herein, the second separator 130 is bonded on the second electrodes 140n to 140n−4 in such a manner that its upper and lower portions are exposed, so that it is possible to stably prevent short-circuit between the first and second electrodes 120n to 120n−5 and 140n to 140n−4 at the time of winding the second separator 130.

In case where the sheet-shaped first and second separators 110 and 130 are stacked, the first terminal 123 and the second terminal 143 are allowed to be disposed on both sides of the first and second separators 110 and 130, respectively, so that it is possible to stably prevent short-circuit between the first and second terminals 123 and 143 at the time of its winding.

In addition, the electrochemical capacitor 100 may further include a fixing member 160 for fixing edge-ends of the wound first and separators 110 and 130. The fixing member 160 may be a tape attached on ends where the first and second separators 110 and 130 finish to be wound. Also, the fixing member 160 may be an adhesive resin coated on ends where the first and second separators 110 and 130 finish to be wound. Also, the adhesive resin may use compositions constituting the first and second adhesion members 151 and 152.

Also, the electrochemical capacitor 100 may further include an electrolyte solution where the first and second separators 110 and 130 and the first and second electrodes 120n to 120n−5 and 140n to 140n−4 are immersed. The electrolyte solution plays a role of a medium for transferring ions, and may be formed of a material which keeps ions stable due to non-occurrence of electrolysis at a high voltage. Herein, the electrolyte solution may include electrolyte and solvent. The electrolyte is in a salt state, for example, a lithium salt, or an ammonium salt. As for the solvent, propylene carbonate, diethylene carbonate, ethylene carbonate, sulfolane, acetonitrile, dimethoxyethane, tetrahydrofuran, and so on may be exemplified. Herein, the solvents may be used individually or in combination with one or more thereof. However, the present invention is not limited by the material of the electrolyte solution.

Also, although not shown in the accompanying drawings, the electrochemical capacitor 100 may further include a housing which receives first and second separators 110 and 130 immersed into the electrolyte solution, and the first and second electrodes 120n to 120n−5 and 140n to 140n−4. The housing may be formed by an aluminum can or an aluminum laminating, but the present invention is not limited by the materials and shapes of the housing.

Therefore, the electrochemical capacitor in accordance with the first embodiment of the present invention is formed in a hybrid structure where includes winding-type separators and stacking-type electrodes, thereby implementing productivity's improvement, as well as yield's improvement. Herein, the productivity's improvement is provided by the winding-type separators, and the yield's improvement is provided by the stacking-type electrodes.

Also, the electrochemical capacitor according to the embodiment of the present invention can prevent short-defect of electrodes due to bending, which result in a decrease in binder's content in the electrodes. Therefore, it is possible to improve electrical characteristics of the electrochemical capacitor.

Hereinafter, a process of manufacturing an electrochemical capacitor in accordance with a second embodiment of the present invention will be described with reference to FIGS. 5 to 8.

FIGS. 5 to 8 are cross-sectional views showing a process of manufacturing the electrochemical capacitor according to the second embodiment of the present invention, respectively.

Referring to FIG. 5, in order to manufacture the electrochemical capacitor, the first electrodes 120n to 120n−5 may be bonded in a row on the sheet-shaped first separator 110. Herein, the first electrodes 120n to 120n−5 have pattern shapes. At this time, in case where the first electrodes 120n to 120n−5 are cathodes, the first electrodes 120n to 120n−5 each may include an cathode current collector 121 and an cathode active material layer 122 coated on both sides of the cathode current collector 121. A first terminal 123 extended from one side of the first electrodes 120n to 120n−5 may further be disposed. The first terminal 123 may be connected to the cathode current collector 121. Herein, the first terminal 123 and the cathode current collector 121 may be formed in a body.

The first electrodes 120n to 120n−5 may be bonded and fixed on the first separator 110 by the first adhesion member 151. Herein, the first adhesion member 151 may include an adhesive resin with stability against the electrolyte solution and the first terminal 123. For example, the adhesive resin may be any one selected from the group consisting of PTFE, PVP, PVdF, EPDM, PDMS, SBR, and CMC, or may be a mixture of two or more thereof. In addition to this, the composition may further include a solvent. As for the solvent, NMP, acetone, and distilled water may be exemplified. Herein, the adhesive resin may be dissolved in the solvent, and thus the composition may be formed in a liquid type.

Herein, the first adhesion member 151 may be formed on the first terminal 123 of the first electrodes 120n to 120n−5. At this time, the first adhesion member 151 is coated only on a partial region of the first terminal 123 overlapped with the first separator 110, in order to prevent the first electrodes 120n to 120n−5 or the first terminal 123 from being contaminated by the first adhesion member 151, so that it is possible to prevent a decrease of electrical characteristics of the electrochemical capacitor. Herein, in case where the composition is formed in a liquid type, the first adhesion member 151 may be formed by a coating method. As for the coating method, an ink-jet printing, a screen printing, and a roll printing may be exemplified. Also, although it has been illustrated in the embodiment of the present invention that the first adhesion member 151 is formed on the first terminal 123, the present invention is not limited thereto. Alternately, the first adhesion member 151 may be formed on the first separator 110 overlapped with the first terminal 123.

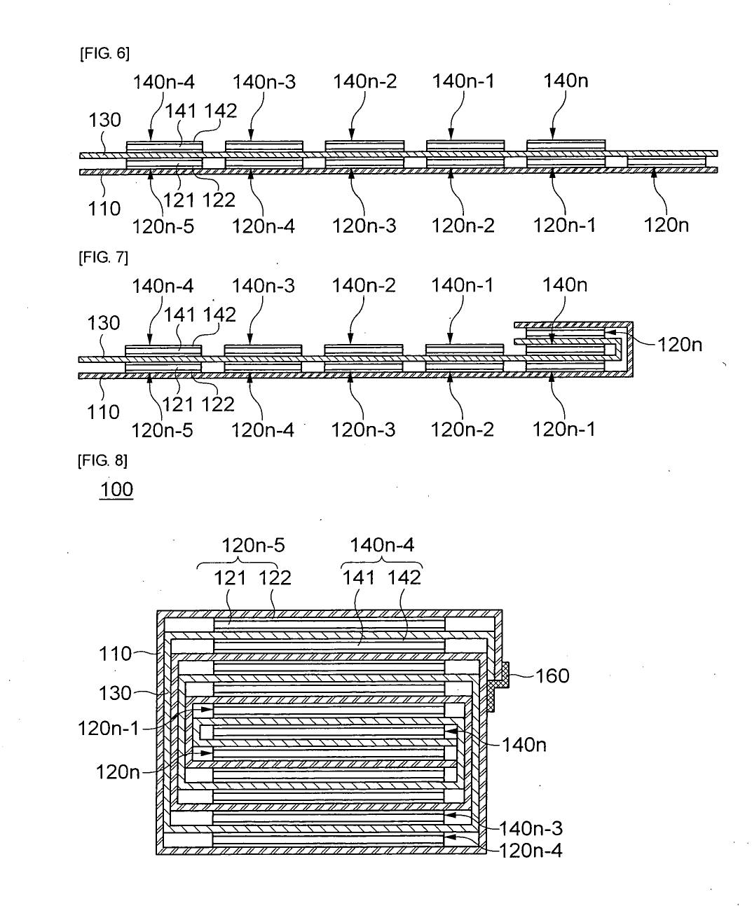

Referring to FIG. 6, the pattern-shaped second electrodes 140n to 140n−4 are bonded in a row on the second separator 130 corresponding to the first separator 110 by using the second adhesion member (indicated by reference numeral 152 of FIG. 4). Herein, after leaving the unoccupied space 45 corresponding to the first electrodes 120n to 120n−5 on one-side end of the second separator 130, that is, point where the winding starts to be made, the first electrodes 120n to 120n−5 are bonded in such a manner to correspond to the second electrodes 140n to 140n−4 from the one side of the unoccupied space 145. Herein, the bonding of the second electrodes 140n to 140n−4 may be made by the bonding method of the first electrodes 120n to 120n−5, and thus the repeated description thereof will be omitted.

In case where the first electrodes 120n to 120n−5 are cathodes, the second electrodes 140n to 140n−4 may be anodes. At this time, the second electrodes 140n to 140n−4 each may include a anode current collector 141 and a anode active material layer 142 coated on both sides of the anode current collector 141. Herein, the second electrodes 140n to 140n−4 may further include a second terminal 143 which is connected to the anode current collector 141 and protruded from the second electrodes 140n to 140n−4. At this time, the anode current collector 141 and the second terminal 143 may be formed in a body.

Although it has been illustrated and described in the embodiment of the present invention that the first electrodes 120n to 120n−5 are cathodes and the second electrodes 140n are anodes, the present invention is not limited thereto. The first electrodes 120n to 120n−5 may be cathodes, and the second electrodes 140n to 140n−4 may be anodes.

The first and second electrodes 120n to 120n−5 and 140n to 140n−4 are bonded and fixed on the first and second separator 110 and 130 through the first and second adhesion members 151 and 152, respectively. Therefore, in a winding process to be described later, it is possible to prevent the first and second electrodes 120n to 120n−5 and 140n to 140n−4 from being departed from the first and second separators 110 and 130, thereby performing easy handling.

Thereafter, the second separator 130 with the second electrodes 140n to 140n−4 is aligned on the first separator 110 with the first electrodes 120n to 120n−5. That is, the first separator 110 and the second separator 130 may be stacked to be opposed to each other. Thus, the second separator 130 may be disposed on the first electrodes 120n to 120n−5, and the first electrodes 120n to 120n−5 and the second electrodes 140n to 140n−4 are disposed to correspond to each other. At this time, the unoccupied space 145 corresponding to the first electrodes 120n to 120n−5 is provided on a point where the second separator 130 begins to be wound.

Referring to FIG. 7, the aligned first and second separators 110 and 130 begin to be wound. At this time, when the first-time winding of the first and second separators 110 and 130 are made, the unoccupied space 145 of the second separator 130 is wound to cover the tope of the second electrode 140n disposed on one side of the unoccupied space 145 of the second separator 130. Thus, at the time of next-time winding, the first electrodes 120n−1 and 120n stacked on the upper and lower portions of the second electrode 140n disposed on one side of the unoccupied space 145 may be electrically separated from each other.

As shown in FIG. 8, by winding the stacked first and second separators 110 and 130 centering on the second electrode 140n disposed on one side of the unoccupied space 145 several times, the first electrodes 120n to 120n−5 and the second electrodes 140n to 140n−4 are alternately stacked between the wound first and second separators 110 and 130, respectively. Thus, the first and second electrodes 120n to 120n−5 and 140n to 140n−4 alternately stacked to one another may be electrically separated by one of the first separator 110 and the second separator 130.

In addition, after winding of the stacked first and second separators 110 and 130 are finished, a point where the first and second separators 110 and 130 finish to be wound may be fixed on the wound first separator 110 of being the outermost layer by using the fixing member 160. Herein, as the fixing member 160, a tape may be used. As other example of the fixing member 160, an adhesive resin coated on a part of end-surface of the first and second separators 110 and 130.

Also, although not shown in the accompanying drawings, the wound first and second separators 110 and 130 and the stacked first and second electrodes 120n to 120n−5 and 140n to 140n−4 are received inside the housing. Thereafter, the electrolyte solution is injected into the housing, and then the opening of the housing is subjected to a sealing process.

Also, in case where the electrochemical capacitor 100 is a lithium ion capacitor, a process for preliminarily doping lithium ions to the second electrodes 140n to 140n−4 (i.e., anodes) may further be performed prior to a process for bonding the second electrodes 140n to 140n−4 on the second separator 130. Also, after the first and second separators 110 and 130 with the first electrodes 120n to 120n−5 and the second electrodes 140n to 140n−4 bonded thereto are wound, there may be performed a process for preliminarily doping lithium ions to the second electrodes 140n to 140n−4 (i.e., anodes). Herein, the process of preliminarily doping lithium ions may be performed either through short-circuit between the second electrodes 140n to 140n−4 and lithium metals, or through a method for performing charging between the first electrodes 120n to 120n−5 and the second electrodes 140n to 140n−4 and performing discharging between the second electrodes 140n to 140n−4 and the lithium metals several times.

In the embodiments of the present invention, since the first electrodes 120n to 120n−5 and the second electrodes 140n to 140n−4 with the pattern shapes are stacked, there is no bending portion on the electrodes, as in the case of the conventional winding type. Therefore, it is possible to prevent the first electrodes 120n to 120n−5 and the second electrodes 140n to 140n−4 from being cracked from the bending of the first and second electrodes, which results in an increase of the yield of the electrochemical capacitor 100.

Also, it is unnecessary to add binder to the first electrodes 120n to 120n−5 and the second electrodes 140n to 140n−4 in consideration of the crack occurrence, which results in improvement of electrical characteristics of the electrochemical capacitor 100.

Also, the first electrodes 120n to 120n−5 and the second electrodes 140n to 140n−4 are bonded and fixed on the first separator 110 and second separator 130 by the first and second adhesion members 151 and 152, and thus the conventional winding scheme where tension is applied is used as it is, so that there is no need to deploy new equipment in manufacturing the hybrid-type electrochemical capacitor. Thus, it is possible to maximize the productivity, as in the case of the winding type. Moreover, it is possible to use the conventional equipment as it is, which results in a reduction of the cost taken for the production equipment.

Also, it is possible to manufacture the hybrid-type electrochemical capacitor even through the conventional winding scheme, and thus to secure close adhesion between the first electrodes 120n to 120n−5 and the second electrodes 140n to 140n−4. Therefore, it is possible to improve electrical characteristics of the electrochemical capacitor. The electrochemical capacitor of the embodiments of the present invention includes winding-type separators and stacking-type electrodes, thereby satisfying both the productivity's improvement effect and the anti-short defect effect which are respectively provided by the stacking type and the winding type.

Also, the electrochemical capacitor according to the embodiments of the present invention can prevent short-defect between the electrodes due to their bending, so that it is possible to decrease binder's content of the electrodes. Therefore, it is possible to improve electrical characteristics of the electrochemical capacitor.

Also, in the electrochemical capacitor according to the embodiments of the present invention, electrodes are bonded to separators, and thus an assembly process may be performed by using the conventional winding equipment. Therefore, there is no need to deploy additional equipment and there is an increase in the speed of the assembly process.

Also, in the electrochemical capacitor according to the embodiments of the present invention, an assembly process is performed by using the conventional winding equipment, thereby maintaining close adhesion between cathodes and anodes. Therefore, it is possible to improve electrical characteristics of the electrochemical capacitor.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An electrochemical capacitor comprising:
at least two winding-type separators which are wound in a spiral shape and are stacked; and
stacking-type first and second electrodes which are alternately interposed between the wound separators, respectively.

2. The electrochemical capacitor according to claim 1, further comprising adhesion members for bonding and fixing the first and second electrodes on the separators.

3. The electrochemical capacitor according to claim 2, wherein each of the adhesion members includes any one selected from the group consisting of PTFE, PVP, PVdF, EPDM, PDMS, SBR, and CMC.

4. The electrochemical capacitor according to claim 1, wherein the first and second electrodes include first and second terminals for connection to an external power source, respectively, the first and second terminals being partially bonded on the separators in such a manner that the first and second electrodes are fixed on the separators.

5. An electrochemical capacitor comprising:
a sheet-shaped first separator;
a plurality of first electrodes which are bonded in a row on the first separator and have pattern shapes;
a first adhesion member for bonding the first electrodes on the first separator;
a sheet-shaped second separator which is disposed above the first separator with the first electrodes;
a plurality of second electrodes which correspond to the first electrodes, respectively, the second electrodes being bonded in a row on the second separator and having pattern shapes; and
a second adhesion member for bonding the second electrodes on the second separator,
wherein the first and second separators are wound in a spiral shape in such a manner that the first and second electrodes are alternately interposed between the wound first and second separators, respectively.

6. The electrochemical capacitor according to claim 5, wherein each of the first and second adhesion members includes adhesive resin.

7. The electrochemical capacitor according to claim 5, wherein each of the first and second adhesion members includes any one selected from the group consisting of PTFE, PVP, PVdF, EPDM, PDMS, SBR, and CMC.

8. The electrochemical capacitor according to claim 5, wherein the first electrode includes a first terminal extensively formed from one side thereof, and the second electrode includes a second terminal extensively formed from the other side thereof, and the first and second adhesion members are interposed between the first separator and a part of the first terminal and between the second separator and a part of the second terminal, respectively.

9. The electrochemical capacitor according to claim 5, wherein the second separator is provided with an unoccupied space at a point where winding starts to be made, in such a manner that the unoccupied space corresponds to the first electrode disposed at a point where winding starts to be made.

10. The electrochemical capacitor according to claim 5, wherein the number of the second electrodes are less by one than the number of the first electrodes.

11. The electrochemical capacitor according to claim 5, wherein the second separator surrounds the second electrode which is disposed in the middle of the stacked second electrodes.

12. A method of manufacturing an electrochemical capacitor comprising:
bonding first electrodes with pattern shapes in a row on a sheet-shaped first separator by using a first adhesion member;
bonding second electrodes with pattern shapes in a row on a sheet-shaped second separator which corresponds to the first separator, by using a second adhesion member;
aligning the second separator with the second electrodes on the first separator with the first electrodes; and
winding the aligned first and second separators in such a manner that the first and second electrodes are alternately stacked.

13. The method of manufacturing an electrochemical capacitor according to claim 12, wherein each of the first and second adhesion members includes adhesive resin.

14. The method acceding to claim 12, wherein each of the first and second adhesion members includes any one selected from the group consisting of PTFE, PVP, PVdF, EPDM, PDMS, SBR, and CMC.

15. The method according to claim 12, wherein, in bonding the second electrodes with pattern shapes in a row on the sheet-shaped second separator corresponding to the first separator by using the second adhesion member, an unoccupied space corresponding to the first electrode disposed on a point where the first separator starts to be wound is provided on a point where the second separator starts to be wound.

16. The method according to claim 15, wherein the first and second adhesion members are coated on partial regions of the first and second terminals, respectively.

17. The method according to claim 15, wherein the first and second adhesion members are coated on the first and second separators, respectively.
